(19) United States
(12) Patent Application Publication
(10) Pub. No.: US 2025/0343405 A1
(43) Pub. Date: Nov. 6, 2025

(54) CIRCUIT BREAKER AND INTERRUPTION METHOD

(71) Applicant: NIPPON TELEGRAPH AND TELEPHONE CORPORATION, Tokyo (JP)

(72) Inventors: Naoki HANAOKA, Tokyo (JP); Toru TANAKA, Tokyo (JP); Naomichi NAKAMURA, Tokyo (JP); Yuji HIGUCHI, Tokyo (JP)

(21) Appl. No.: 18/855,458

(22) PCT Filed: Apr. 11, 2022
(86) PCT No.: PCT/JP2022/017504

§ 371 Date: Oct. 9, 2024

(51) Int. Cl. H02H 7/20

(52) U.S. Cl. CPC H02H 7/20

(57) ABSTRACT

Provided is a breaker including a plurality of breaking circuits for breaking a current, in which the plurality of breaking circuits include capacitors on output sides that are not connected with each other.

### TECHNICAL FIELD

The present invention relates to a circuit breaker and an interruption method.

### BACKGROUND ART

In a power supply system, a DC breaker may be installed for wiring protection or the like. In particular, in an outdoor power supply system, various power sources (solar power (PV: photovoltaics), wind power, or the like) and loads (an electric vehicle (EV), a storage battery, or the like) are bidirectionally connected to form a complicated power network (Non Patent Literature 1).

### CITATION LIST

### Non Patent Literature

Non Patent Literature 1: Kensuke Murai et al., “Evaluation of semiconductor breaker for HVDC power supply system”, Internet <URL: https://ci.nii.ac.jp/naid/110008675353>

### SUMMARY OF INVENTION

### Technical Problem

Conventionally, in the complicated network, there are inputs and outputs not only in two directions but also in three directions, four directions, and the like, and therefore, it is necessary to create a dedicated DC breaking unit (e.g., for three directions, four directions, etc.) for each type (the number of directions). As a result, there is a problem that it is difficult to integrate (downsize) a device of a branch breaking circuit using a semiconductor switch.

An object of a disclosed technology is to realize integration of a branch breaking circuit capable of coping with a complicated network.

### Solution to Problem

The disclosed technology relates to a breaker including a plurality of breaking circuits for breaking a current, and the plurality of breaking circuits includes capacitors on output sides that are not connected to each other.

### Advantageous Effects of Invention

It is possible to realize integration of a branch breaking circuit capable of coping with a complicated network.

### BRIEF DESCRIPTION OF DRAWINGS

FIG. 1 is a diagram illustrating an example of a configuration of a power supply system according to the present embodiment.

FIG. 2 is a diagram illustrating a circuit of a breaker divergently extending in two directions.

FIG. 3 is a diagram illustrating a circuit of a breaker divergently extending in three directions.

FIG. 4 is a diagram illustrating a circuit of a breaker divergently extending in four directions.

FIG. 5 is a diagram illustrating an example of the appearance of a housing of the breaker according to Example 1 of the embodiment of the present invention.

FIG. 6 is a first diagram illustrating an example of an internal wiring of the housing of the breaker according to Example 1 of the embodiment of the present invention.

FIG. 7 is a diagram illustrating an example of a conventional breaking unit.

FIG. 8 is a diagram illustrating an example of an internal circuit of a conventional breaking unit.

FIG. 9 is a diagram illustrating an example of a breaking unit according to Example 1 of the embodiment of the present invention.

FIG. 10 is a diagram illustrating a circuit of a breaker divergently extending in five directions.

FIG. 11 is a diagram illustrating a circuit of a breaker divergently extending in six directions.

FIG. 12 is a second diagram illustrating an example of the internal wiring of the housing of the breaker according to Example 1 of the embodiment of the present invention.

FIG. 13 is a view illustrating an appearance of the housing of the breaker in a modification of Example 1 of the embodiment of the present invention.

FIG. 14 is a diagram illustrating an example of a conventional bidirectional power supply system.

FIG. 15 is a sequence diagram illustrating an example of a flow of handshaking in the conventional bidirectional power supply system.

FIG. 16 is a diagram illustrating a configuration of the power supply system according to Example 2 of the embodiment of the present invention.

FIG. 17 is a flowchart illustrating an example of a flow of control processing according to Example 2 of the embodiment of the present invention.

FIG. 18 is a flowchart illustrating an example of a flow of power feeding path determination processing according to Example 2 of the embodiment of the present invention.

FIG. 19 is a first diagram for explaining a power feeding path determination method according to Example 2 of the embodiment of the present invention.

FIG. 20 is a second diagram for explaining the power feeding path determination method according to Example 2 of the embodiment of the present invention.

FIG. 21 is a diagram for explaining a method of locking the power feeding path and setting protection coordination according to Example 2 of the embodiment of the present invention.

FIG. 22 is a diagram illustrating a hardware configuration example of a computer.

FIG. 23 is a diagram for explaining a conventional breaking circuit.

FIG. 24 is a diagram for explaining a conventional branch breaking circuit.

FIG. 25 is a diagram illustrating an example of a branch breaking circuit according to Example 3 of the embodiment of the present invention.

FIG. 26 is a diagram illustrating an example of the housing of the breaker according to Example 3 of the embodiment of the present invention.

FIG. 27 is a diagram illustrating an example of the circuit of the breaker according to Example 3 of the embodiment of the present invention.

### DESCRIPTION OF EMBODIMENTS

Hereinafter, each embodiment (present embodiment) of the present invention will be described with reference to the drawings. The embodiment described below is merely an example, and embodiments to which the present invention is applied is not limited to the following embodiment.

### Outline of Present Embodiment

A power supply system according to the present embodiment assumes a case where various power sources (solar power (PV: photovoltaics), wind power, or the like) and loads (an electric vehicle (EV), a storage battery, and the like) are bidirectionally connected, such as a case where the power supply system is used outdoors. Therefore, connection points are situated in not only two directions but also three directions, four directions, and the like, and it is necessary to customize breakers for protection individually according to the number of branches.

Note that the breaker according to the present embodiment may include a DC breaker or an AC breaker. Moreover, the breaker according to the present embodiment may include any breaker of a mechanical type, a hybrid type, and a semiconductor type.

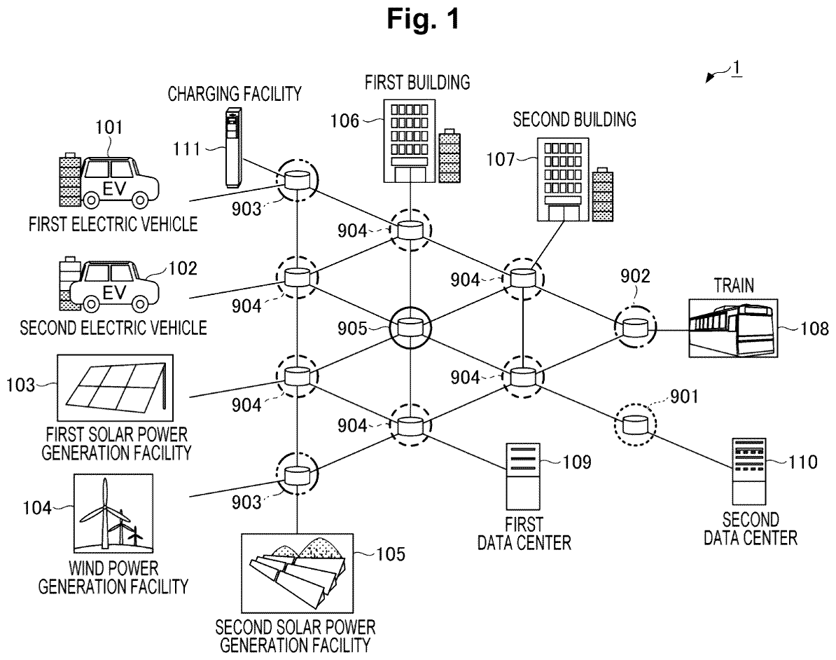

FIG. 1 is a diagram illustrating an example of a configuration of the power supply system according to the present embodiment. In a power supply system 1, a plurality of power sources, loads, and the like are connected to one another by a power feeding network. The power sources, the loads, and the like include, for example, a first electric vehicle 101, a second electric vehicle 102, a first solar power generation facility 103, a wind power generation facility 104, a second solar power generation facility 105, a first building 106, a second building 107, a train 108, a first data center 109, a second data center 110, and a charging facility 111.

A breaker is installed at each branch point of the power feeding network. For example, a two-way breaker 901 is a breaker that divergently extends in two directions. Similarly, a three-way breaker 902 divergently extending in three directions, four-way breakers 903 divergently extending in four directions, five-way breakers 904 divergently extending in five directions, and a six-way breaker 905 divergently extending in six directions are installed at respective branch points of the power feeding network.

In a case where a customer side or the like is connected by outdoor power distribution (power network of bus type, loop type, mesh type, etc.), an accident point can be actively separated in a short time in the event of an accident, by disposing a breaker at a branch point.

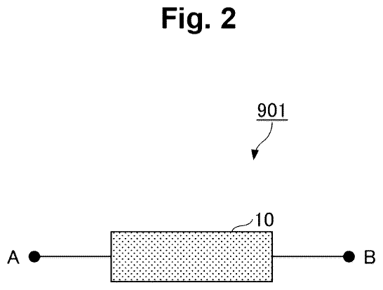

FIG. 2 is a diagram illustrating a circuit of the breaker divergently extending in two directions. The two-way breaker 901 includes one breaking unit 10. The breaking unit 10 is connected between A and B. The breaking unit 10 can break currents in two directions, i.e., from A to B, and from B to A.

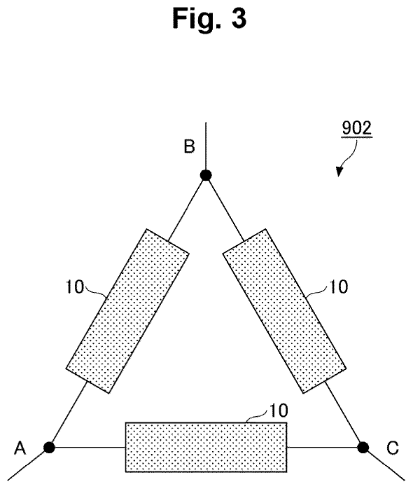

FIG. 3 is a diagram illustrating a circuit of the breaker divergently extending in three directions. A three-way breaker 902 includes three breaking units 10. The breaking units 10 are connected respectively between A and B, between B and C, and between A and C. Each breaking unit 10 can break the current in two directions between two connected points. As a result, the three-way breaker 902 can break currents in all directions that are defined by combinations of the three points A, B, and C.

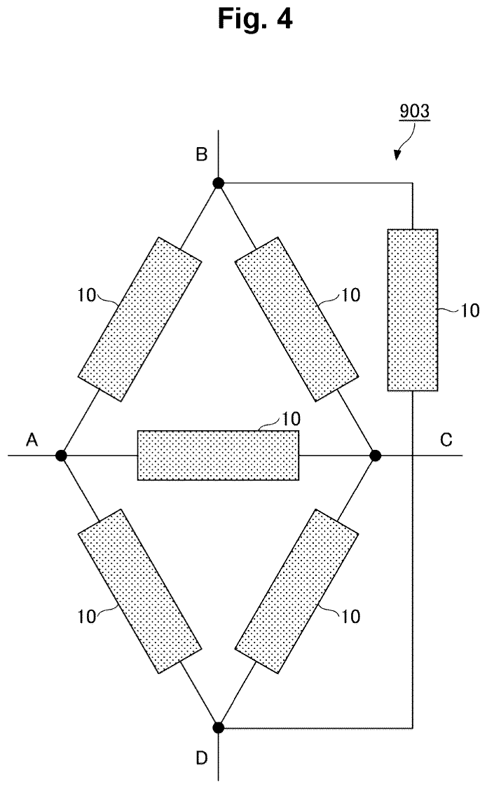

FIG. 4 is a diagram illustrating a circuit of the breaker divergently extending in four directions. A four-way breaker 903 includes six breaking units 10. The breaking units 10 are connected respectively between A and B, between A and C, between A and D, between B and C, between B and D, and between C and D. Each breaking unit 10 can break the current in two directions between two connected points. As a result, the four-way breaker 903 can break currents in all directions that are defined by combinations of the four points A, B, C, and D.

Hereinafter, Examples 1 to 3 will be described using specific examples of the present embodiment.

### Example 1

In the present example, the breaker can be expanded by combining breaking units capable of breaking the current in two directions, with an external housing having a plurality of slots. Specifically, an example in which divergent extension in multiple directions, such as three directions or four directions, is enabled by changing the position of a slot in which each breaking unit is inserted will be described.

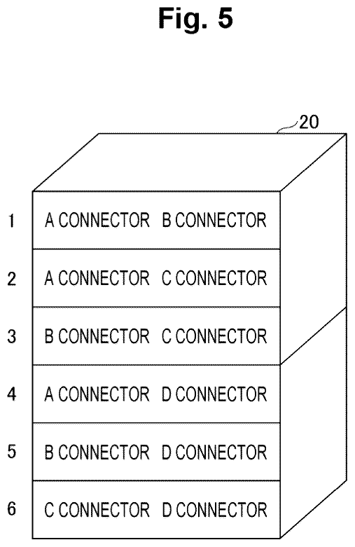

FIG. 5 is a view illustrating an example of the appearance of a housing of the breaker according to Example 1 of the embodiment of the present invention. A housing 20 is designed such that a plurality of (e.g., six in the example in FIG. 5) breaking units 10 can be inserted in the housing 20. The breaking units 10 inserted in the respective slots are connected between different points. For example, a breaking unit 10 inserted in a first slot is connected between a connector A and a connector B, and a breaking unit 10 inserted in a second slot is connected between the connector A and a connector C.

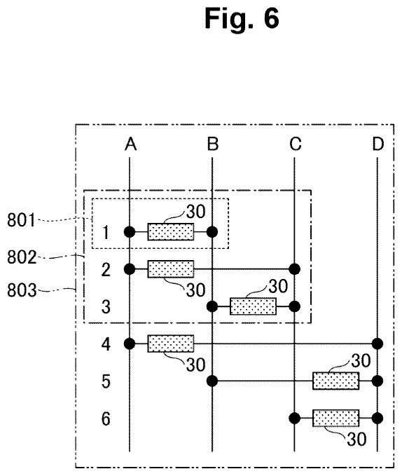

FIG. 6 is a first diagram illustrating an example of an internal wiring of the housing of the breaker according to Example 1 of the embodiment of the present invention. The housing 20 illustrated in FIG. 5 has six slots 30 in which six breaking units 10 can be inserted. The breaking units 10 inserted in the respective slots 30 are wired in advance so as to be connected between different points.

For example, a circuit including the first slot 30 functions as a two-way circuit 801. A breaker including a breaking unit 10 inserted in the first slot 30 and the housing 20 functions as the two-way breaker 901.

Moreover, for example, a circuit including the first to third slots 30 functions as a three-way circuit 802. A breaker including breaking units 10 inserted in the first to third slots 30 and the housing 20 functions as the three-way breaker 902.

Moreover, for example, a circuit including the first to sixth slots 30 functions as a four-way circuit 803. A breaker including breaking units 10 inserted in the first to sixth slots 30, six in total, and the housing 20 functions as the four-way breaker 903.

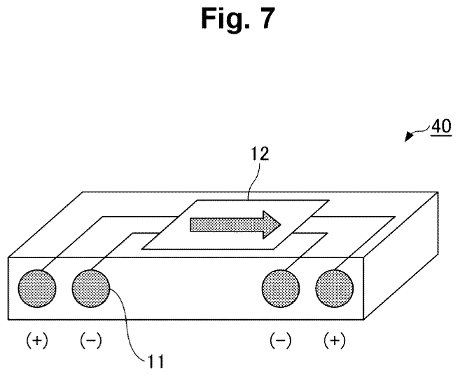

FIG. 7 is a diagram illustrating an example of a conventional breaking unit. A breaking unit 40 conventionally often used includes four connectors 11 and one internal circuit 12.

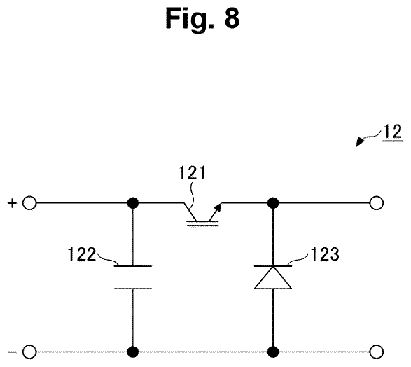

FIG. 8 is a diagram illustrating an example of the internal circuit of the conventional breaking unit. The internal circuit 12 includes, for example, a switch 121, a capacitor 122, and a diode 123. The capacitor 122 functions to suppress voltage fluctuation when the circuit is broken for a short time. Moreover, the diode 123 functions to suppress overvoltage when the circuit is broken for a long time. Such an internal circuit 12 can break only a current in one direction.

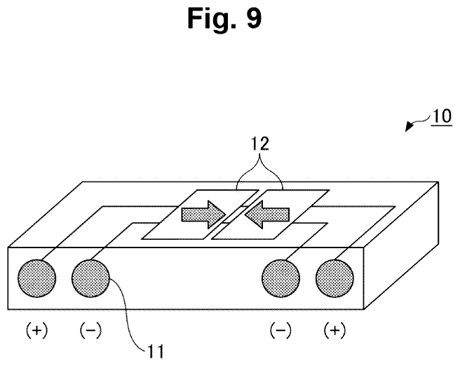

FIG. 9 is a diagram illustrating an example of a breaking unit according to Example 1 of the embodiment of the present invention. The breaking unit 10 according to this example includes four connectors 11 and two internal circuits 12. Each internal circuit 12 may be the circuit illustrated in FIG. 8. The internal circuits 12 are connected in series in opposite directions. As a result, the breaking unit 10 can break the current in two directions (bidirectional current).

A breaker divergently extending in multiple directions is configured by combining the above-described breaking units 10 and the housing 20. Although breakers in four or less directions have been described, breakers expanded to five or more directions can be similarly configured.

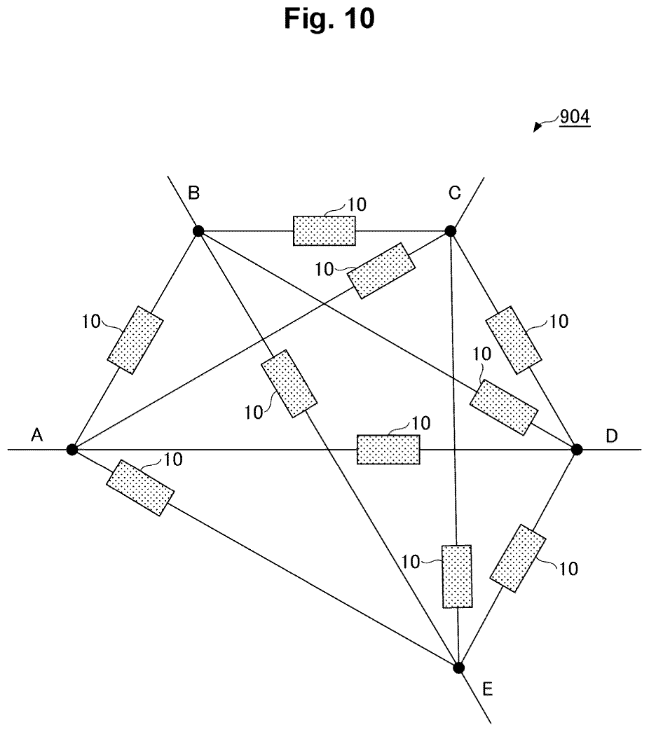

FIG. 10 is a diagram illustrating a circuit of a breaker divergently extending in five directions. The five-way breaker 904 includes 10 breaking units 10. The breaking units 10 are respectively connected between A and B, between A and C, between A and D, between A and E, between B and C, between B and D, between B and E, between C and D, between C and E, and between D and E. Each breaking unit 10 can break a current in two directions between two connected points. As a result, the five-way breaker 904 can break currents in all combinations of the five points A, B, C, D, and E.

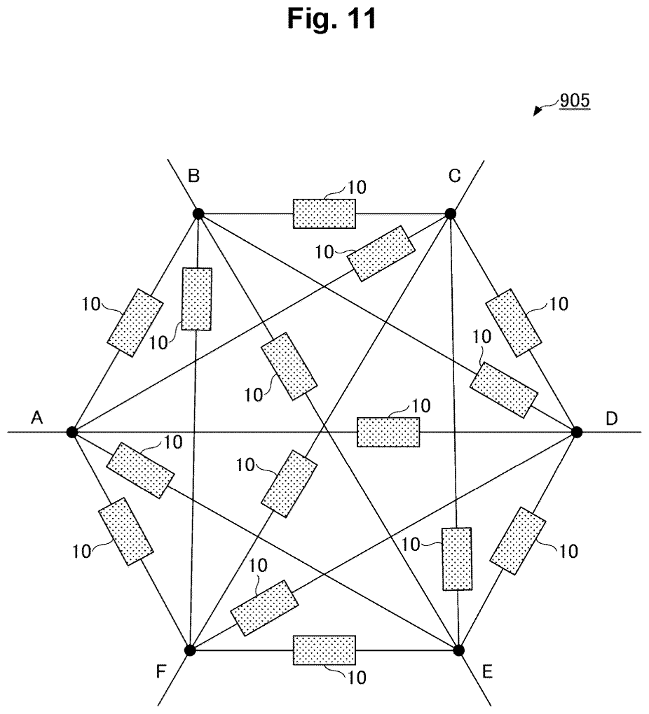

FIG. 11 is a diagram illustrating a circuit of a breaker divergently extending in six directions. The six-way breaker 905 includes 15 breaking units 10. The breaking units 10 are respectively connected between A and B, between A and C, between A and D, between A and E, between A and F, between B and C, between B and D, between B and E, between B and F, between C and D, between C and E, between C and F, between D and E, between D and F, and between E and F. Each breaking unit 10 can break a current in two directions between two connected points. As a result, the six-way breaker 905 can break currents in all combinations of the six points A, B, C, D, E, and F.

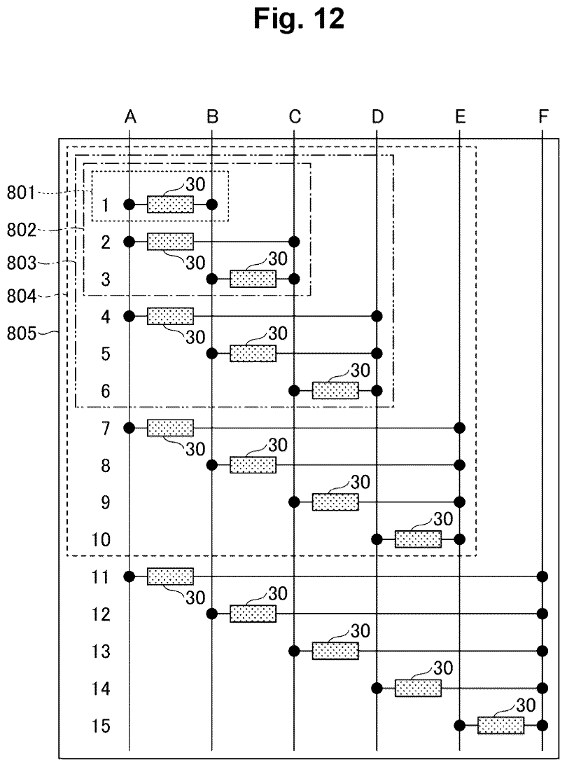

FIG. 12 is a second diagram illustrating an example of internal wiring of the housing of the breaker according to Example 1 of the embodiment of the present invention. The housing 20 has 15 slots 30 in which 15 breaking units 10 can be inserted. The breaking units 10 inserted in the respective slots 30 are wired in advance so as to be connected between different points.

For example, a circuit including the first slot 30 functions as a two-way circuit 801. A breaker including a breaking unit 10 inserted in the first slot 30 and the housing 20 functions as the two-way breaker 901.

Moreover, for example, a circuit including the first to third slots 30 functions as a three-way circuit 802. A breaker including breaking units 10 inserted in the first to third slots 30 and the housing 20 functions as the three-way breaker 902.

Moreover, for example, a circuit including the first to sixth slots 30 functions as a four-way circuit 803. A breaker including breaking units 10 inserted in the first to sixth slots 30, six in total, and the housing 20 functions as the four-way breaker 903.

Moreover, for example, a circuit including the first to tenth slots 30 functions as a five-way circuit 804. A breaker including breaking units 10 inserted in the first to tenth slot 30, 10 in total, and the housing 20 functions as the five-way breaker 904.

Moreover, for example, a circuit including the first to fifteenth slots 30 functions as a six-way circuit 805. A breaker including breaking units 10 inserted in the first to fifteenth slots 30, 15 in total, and the housing 20 functions as the six-way breaker 905.

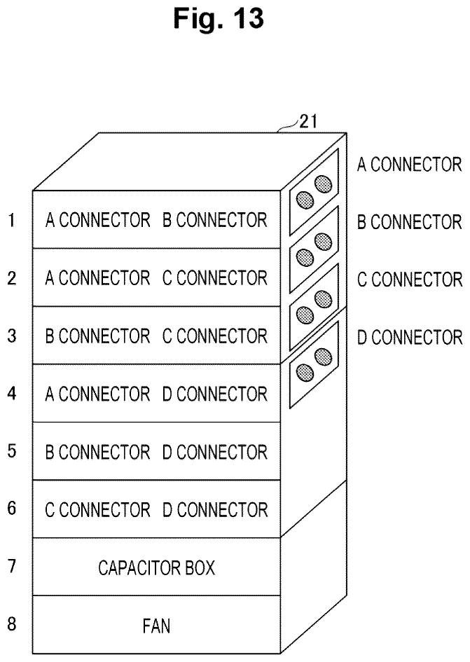

FIG. 13 is a view illustrating the appearance of the housing of the breaker in a modification of Example 1 of the embodiment of the present invention. A housing 21 illustrated in FIG. 13 includes six slots 30 for implementing the four-way breaker 903, and further includes a seventh slot for inserting a capacitor box, and an eighth slot for inserting a fan. The capacitor box may be, for example, a capacitor that suppresses an electric arc at the time of breaking, a transient voltage countermeasure circuit, an overcurrent countermeasure circuit, or the like. Moreover, the fan may be a cooler for cooling generated heat due to conduction loss at a contact at which a direct current is interrupted.

Moreover, the housing 21 has four connectors A to D that are directed outward. The connectors are respectively connected with various power sources, the loads, and the like in the power feeding network.

According to the housing 20 (or the housing 21) and the breaking unit 10 according to the present example, the configuration of the breaker divergently extending in multiple directions can be simplified by combining breaking units 10 capable of breaking in two directions, with the external housing 20 having a plurality of slots. For example, since a breaker divergently extending in a plurality of types of directions can be configured with one type of breaking units 10, the breaking units 10 can be mass-produced.

Although this example has illustrated using an example in which the circuit is incorporated in the housing 20 (or the housing 21), a part or all of the circuit may be incorporated in the breaking units 10.

Moreover, although an example in which the current in two directions (bidirectional current) is broken has been described using the breaking unit 10, a breaking unit that breaks the current in one direction (unidirectional current) may be used.

With the breaker according to this example, branch points in multiple directions, such as two directions, three directions, four directions, five directions, or six directions can be configured with one type (or several types) of slot type breaker in a microgrid capable of interchanging AC power and/or DC power.

Power routing is also possible by controlling ON/OFF of the breaker according to this example for each port.

### Example 2

This example will be explained using a control method in which a power supply system including branch points in multiple directions as illustrated in FIG. 1 has an interlocking function of locking a one-to-one or n-to-n power feeding path for a certain period of time to secure the power feeding path so that the power feeding path does not intersect with another power feeding path during power feeding, and in the control method, a current amount for performing overcurrent protection (OCP) is set in a breaker so as to achieve a protection coordination function in a case where the power feeding path during power feeding branches, in order to ensure safety.

For comparison, control in a conventional bidirectional power supply system will be described.

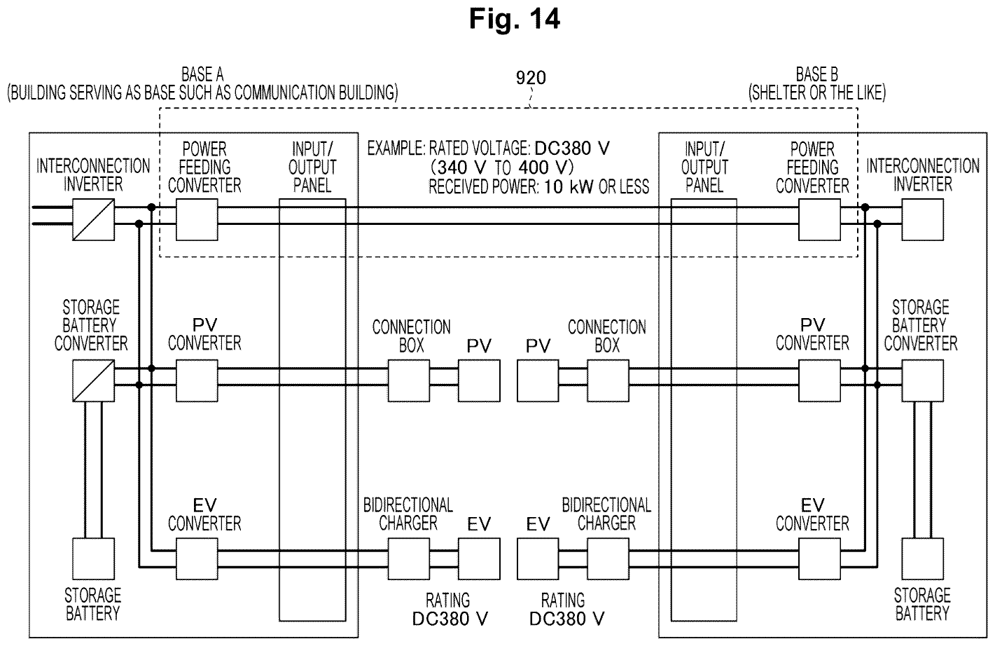

FIG. 14 is a diagram illustrating an example of a conventional bidirectional power supply system. A power supply system 920 for bidirectionally feeding power between a base A and a base B includes a power feeding converter at each base. The base A is an example of a building serving as a base such as a communication building. The base B is, for example, a shelter or the like.

Converters perform communication (handshaking) with each other and then perform power interchange. As a result, it is possible to perform the power interchange bidirectionally on a one-to-one basis between bases. Note that a breaker serving as a connection point may not be disposed between bases.

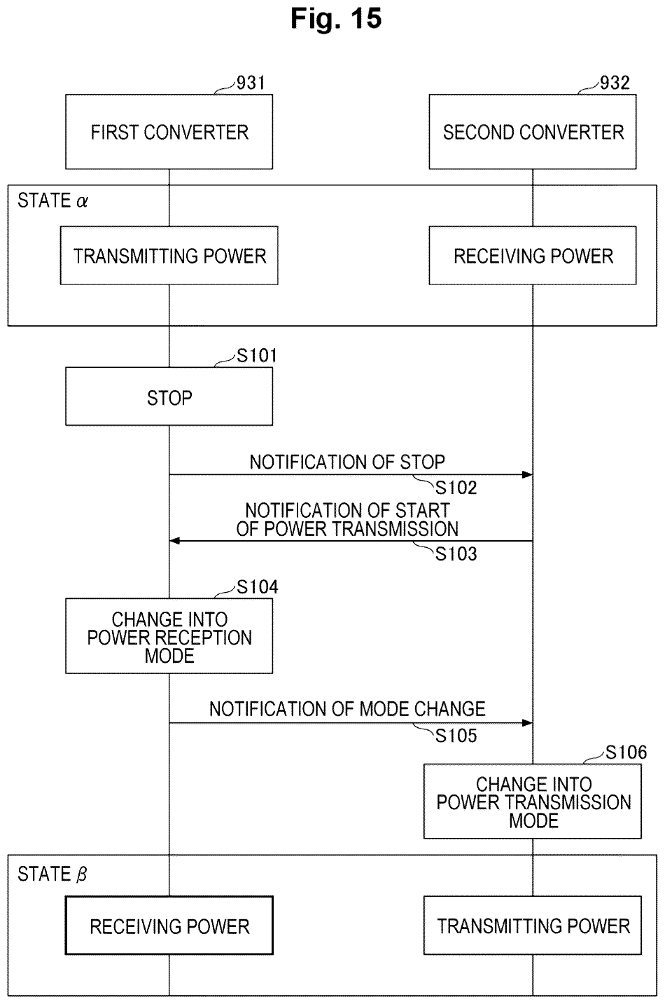

FIG. 15 is a sequence diagram illustrating an example of a flow of handshaking in a conventional bidirectional power supply system. A converter disposed at the base A is referred to as a first converter 931, and a converter disposed at the base B is referred to as a second converter 932.

It is assumed that the first converter 931 is transmitting power (in power transmission mode) and the second converter 932 is receiving the power (in power reception mode). This state is referred to as a state α. Moreover, a state in which the first converter 931 is receiving the power (in power reception mode) and the second converter 932 is transmitting the power (in power transmission mode) is referred to as a state β.

FIG. 15 illustrates a flow of transition from the state α to the state β. The first converter 931 stops power transmission (step S101). Next, the first converter 931 notifies the second converter 932 of the stopping (step S102).

Upon receiving the notification of the stop, the second converter 932 notifies the first converter 931 of a start of power transmission (step S103). Upon receiving the notification of the start of power transmission, the first converter 931 changes the operation mode to the power reception mode (step S104).

Subsequently, the first converter 931 notifies the second converter 932 of the change of the operation mode (step S105). Upon receiving the notification of the operation mode change, the second converter 932 changes the operation mode to the power transmission mode (step S106). Through the above procedure, the transition from the state α to the state β is completed.

Next, a control procedure of the breaker and the converter according to this example will be described.

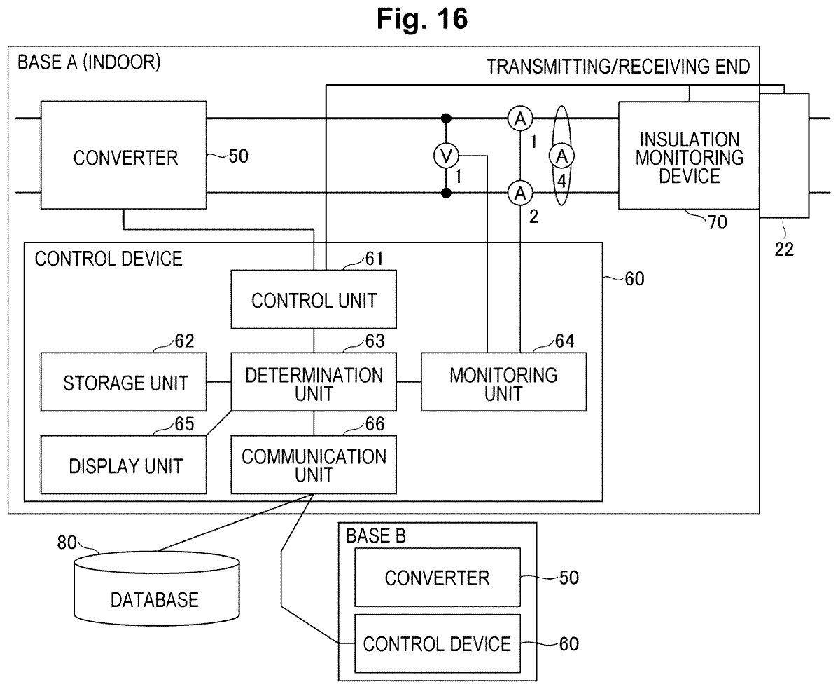

FIG. 16 is a diagram illustrating a configuration of a power supply system according to Example 2 of the embodiment of the present invention. In each base, a control device for controlling a converter of each base and a breaker disposed in a power feeding network is installed. In a base A, a converter 50, a control device 60, and an insulation monitoring device 70 are installed.

The control device 60 includes a control unit 61, a storage unit 62, a determination unit 63, a monitoring unit 64, a display unit 65, and a communication unit 66. The control unit 61 controls the converter 50 and a breaker 22. The storage unit 62 stores information such as a threshold necessary for control.

The determination unit 63 performs determination processing for determining an operation mode of each converter, determining a power feeding path, and the like. The monitoring unit 64 monitors an operation mode of power feeding by the converter 50 by using a detection result of an ammeter, a voltmeter, or the like. The display unit 65 displays control contents. The communication unit 66 communicates with a database 80 and a control device 60 (installed in another base (base B, etc.)).

The database 80 stores a learned model or the like generated by analysis, learning, or the like. Note that the database 80 may be of a centralized type or a distributed type.

Next, the operation of the control device 60 will be described.

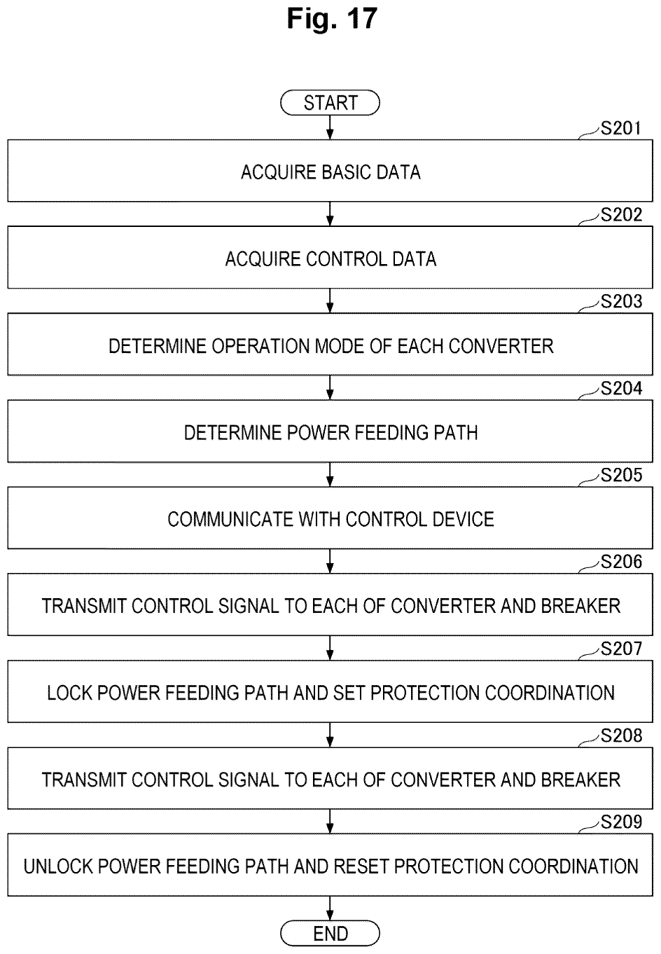

FIG. 17 is a flowchart illustrating an example of a flow of control processing according to Example 2 of the embodiment of the present invention.

The control device 60 acquires basic data (step S201). The basic data may be, for example, GB operation time, X-capacitor capacity, cable impedance, fuse blowout characteristics, power network configuration, slot type breaker information, currently locked route information, or the like.

Next, the control device 60 acquires control data (step S202). The control data may be a specification of a power transmittable converter, a specification of a power receivable converter, PV power, SoC of a storage battery, load capacity, weather information, weather forecast information, and the like. Note that the control device 60 may receive an input of control data.

Next, the determination unit 63 determines an operation mode of each converter (step S203). Specifically, in a state where the converter 50 of the base A is transmitting power to the base B, the determination unit 63 controls the converter 50 of the base B to be in the power reception mode and not to be in the power transmission mode. Here, the monitoring unit 64 detects the power transmission state by a control signal, a detector, or the like.

Similarly, in a state where the converter of the base B is transmitting power to the base A, the determination unit 63 controls the converter 50 of the base A to be in the power reception mode and not to be in the power transmission mode.

Next, the determination unit 63 determines a power feeding path (step S204). Details of the power feeding path determination method will be described later.

Subsequently, the communication unit 66 communicates with the control device (step S205). Note that, when the operation mode is changed, the control device 60 may execute the handshaking procedure illustrated in FIG. 15. Then, the control unit 61 transmits a control signal to each of the converter 50 and the breaker 22 (step S206).

Subsequently, the control unit 61 locks the power feeding path and sets protection coordination (step S207). A method of locking the power feeding path and setting the protection coordination will be described later.

The control unit 61 transmits a control signal to each of the converter 50 and the breaker 22 in accordance with setting contents (step S208). When detecting elapse of a certain period of time or pressing of an emergency stop signal, the control unit 61 unlocks the power feeding path and resets the protection coordination (step S209).

Subsequently, a method of determining the power feeding path in step S204 of FIG. 17 described above will be described.

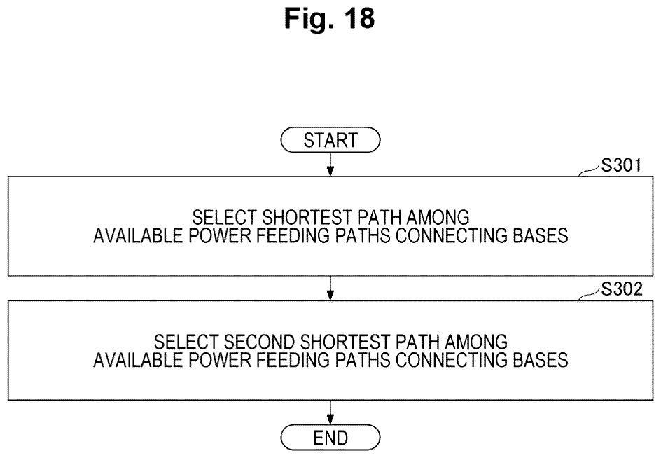

FIG. 18 is a flowchart illustrating an example of a flow of power feeding path determination processing according to Example 2 of the embodiment of the present invention.

The determination unit 63 selects the shortest path among available power feeding paths connecting the bases (step S301). Next, the determination unit 63 selects the second shortest path among the available power feeding paths connecting the bases (step S302).

Although FIG. 18 illustrates a configuration example of power feeding in a one-to-one manner, the determination unit 63 may provide a current threshold for power feeding in an n-to-n manner and execute similar interlocking. In the case of n-to-n power feeding, not only that the interlocking is based on the power transmission mode and the power reception mode but also that the sum of the transmission power and the sum of the reception power (+power transmission loss) match may be used as the interlocking condition.

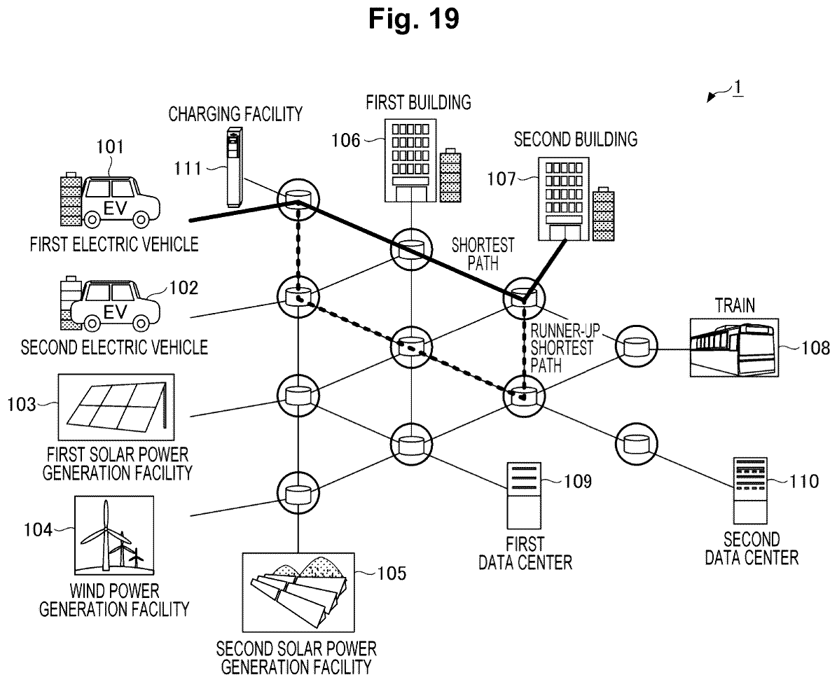

FIG. 19 is a first diagram for explaining a power feeding path determination method according to Example 2 of the embodiment of the present invention.

FIG. 19 illustrates a method of determining the power feeding path in the case of one-to-one power feeding. In the case of one-to-one power feeding, the determination unit 63 determines the shortest path and the second shortest path. By determining a plurality of power feeding paths, impedance of the power feeding path can be reduced, and wiring loss can be also reduced.

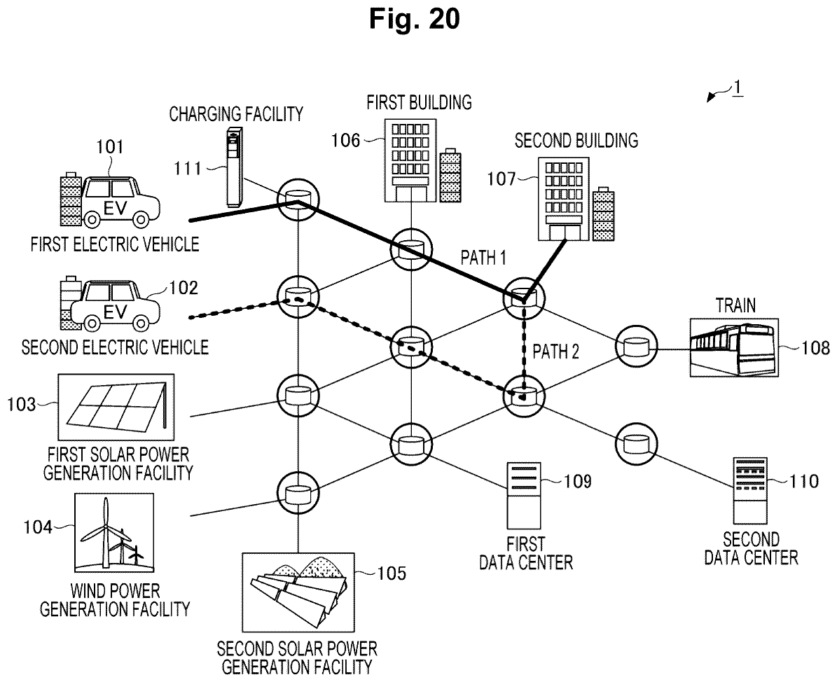

FIG. 20 is a second diagram for explaining a power feeding path determination method according to Example 2 of the embodiment of the present invention.

FIG. 20 illustrates the method of determining the power feeding path in the case of one-to-two power feeding. In the case of one-to-two power feeding, the determination unit 63 determines, for example, a path for supplying power from the second building 107 to the first electric vehicle 101 (path 1) and to the second electric vehicle 102 (path 2). Since there is a branch of the feeder line, it is necessary to limit the maximum current before and after the branch for protection coordination at the branch point.

Subsequently, a method of locking the power feeding path and setting the protection coordination in step S207 of FIG. 17 described above will be described.

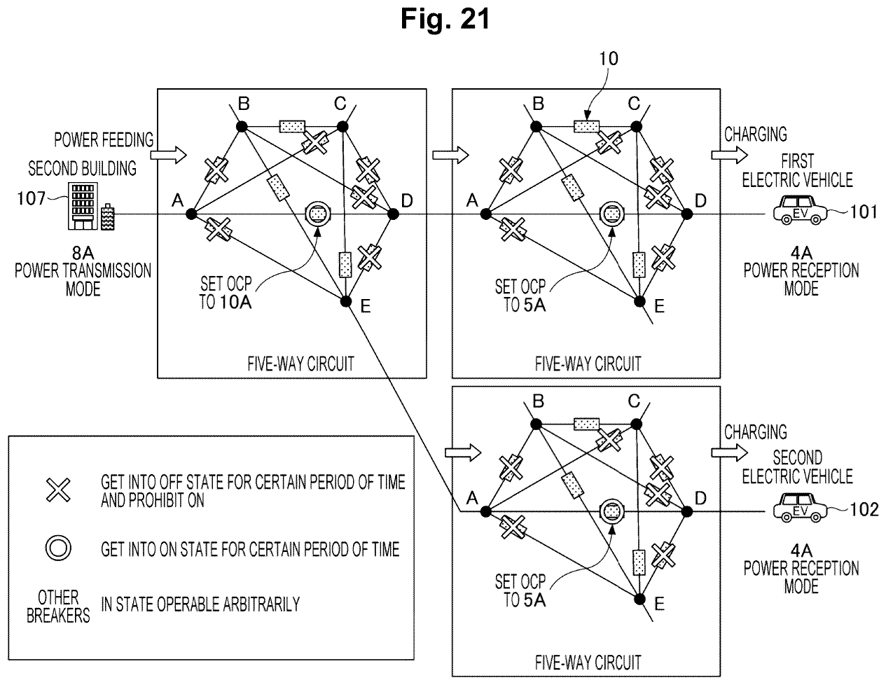

FIG. 21 is a diagram for explaining a method of locking the power feeding path and setting the protection coordination according to Example 2 of the embodiment of the present invention.

The control unit 61 turns on all breakers 22 installed on a power feeding path connecting a converter 50 in the power transmission mode and a converter 50 in the power reception mode. Moreover, the control unit 61 fixes all breakers 22 installed on a path intersecting the power feeding path to OFF (interlocking). Moreover, the control unit 61 recognizes that the other breakers 22 are usable in another route. In this manner, the control unit 61 executes locking of the power feeding path.

Moreover, the control unit 61 sets the OCP of the breaker 22 according to the number of branches of the path like a fuse, a wiring breaker, or the like. In this way, the control unit 61 executes setting of the protection coordination. This eliminates the need for cost, time, and the like for constructing a new route.

It is possible to implement the control device 60, for example, by causing a computer to execute a program in which the processing contents described in the present embodiment are described. Note that the “computer” may be a physical machine or a virtual machine on a cloud. In a case where a virtual machine is used, “hardware” to be described herein is virtual hardware.

The above program can be stored and distributed by being recorded on a computer-readable recording medium (portable memory, etc.). The above program can also be provided through a network such as the Internet or an electronic mail.

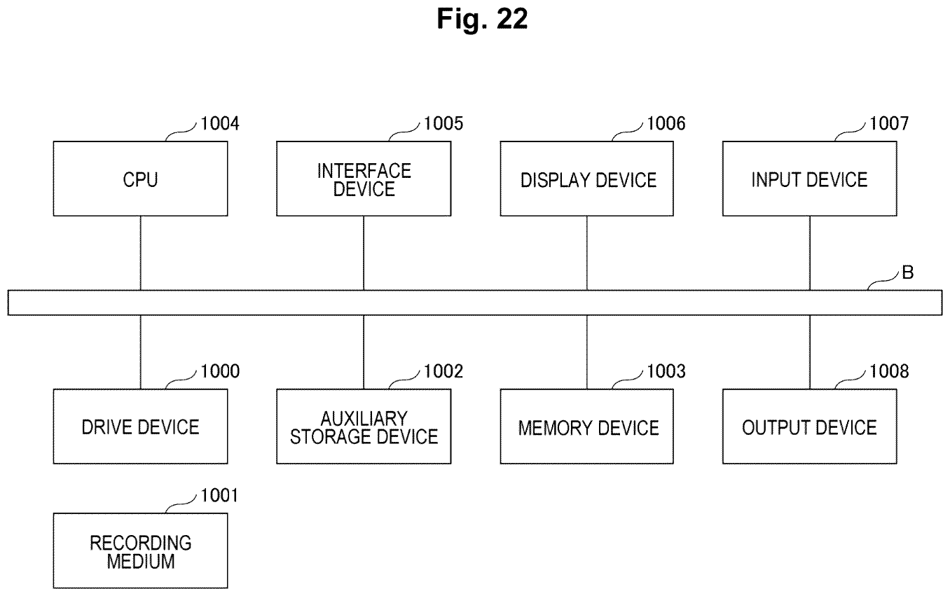

FIG. 22 is a diagram illustrating a hardware configuration example of the computer. The computer in FIG. 22 includes a drive device 1000, an auxiliary storage device 1002, a memory device 1003, a CPU 1004, an interface device 1005, a display device 1006, an input device 1007, an output device 1008, and the like, which are connected with each other by a bus B.

A program for implementing processing in the computer is provided through a recording medium 1001 such as a CD-ROM or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

When an instruction to start the program is made, the memory device 1003 reads the program from the auxiliary storage device 1002 and stores the program. The CPU 1004 implements a function related to the device in accordance with the program stored in the memory device 1003. The interface device 1005 is used as an interface for connection to a network. The display device 1006 displays a graphical user interface (GUI) or the like according to the program. The input device 1007 is configured with a keyboard and a mouse, a button, a touch panel, or the like, and is used to input various operation instructions. The output device 1008 outputs a computation result. Note that the computer may include a graphics processing unit (GPU) or a tensor processing unit (TPU) instead of the CPU 1004, or may include a GPU or a TPU in addition to the CPU 1004. In that case, for example, processing may be shared and executed such that the GPU or the TPU executes processing requiring special computation and the CPU 1004 executes other processing.

According to this example, the control device 60 realizes the interlocking function and the protection coordination function by locking the power feeding path and setting the protection coordination. By interlocking for a certain period of time, cables (routes) related to power feeding and power reception can be separated from other power feeding routes in a pseudo manner, and an independent safe route can be constructed. Moreover, physical extension reconstruction is not required to change the route.

Moreover, in a case where power interchange is bidirectionally performed by the converter, even when a short circuit occurs in outdoor wiring via a large resistor, all the converters do not get into the power transmission state at the same time, and an accident can be detected.

As a result, it is possible to improve the safety of the power feeding path in the power supply system capable of coping with a complicated network.

### Example 3

In this example, an example of realizing integration of the branch breaking circuit will be described.

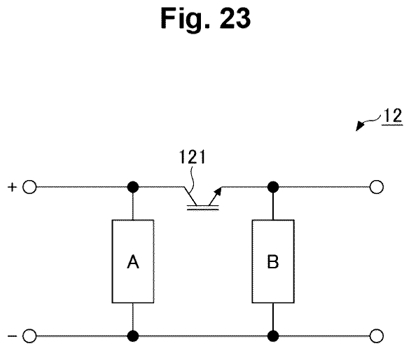

FIG. 23 is a diagram for explaining a conventional breaking circuit. An internal circuit 12 includes a switch 121, and A and B. In A of FIG. 23, a capacitor or the like is used to suppress voltage fluctuation when the circuit is broken in a short time. In B of FIG. 23, a capacitor, a diode, or the like is used to suppress overvoltage when the circuit is broken in a long time.

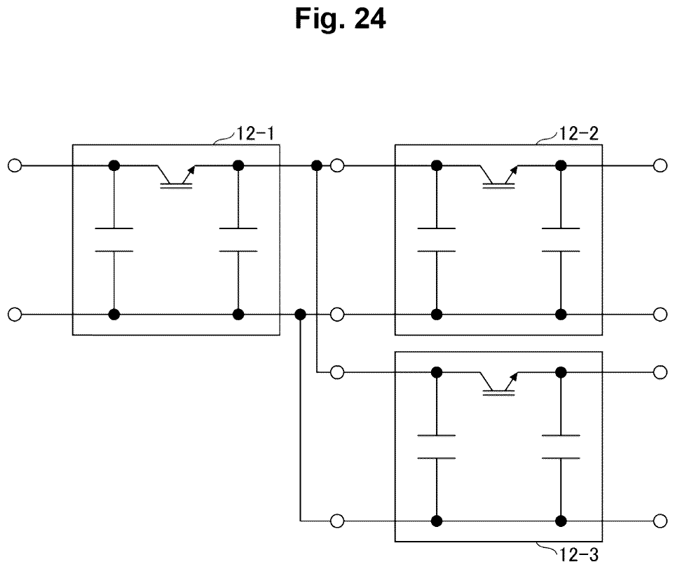

FIG. 24 is a diagram for explaining a conventional branch breaking circuit. Conventionally, as illustrated as internal circuits 12-1 to 12-3 of FIG. 24, branching has been realized by arranging the circuits of FIG. 23. That is, the branch breaking circuit has not been conventionally regarded as an integrated device.

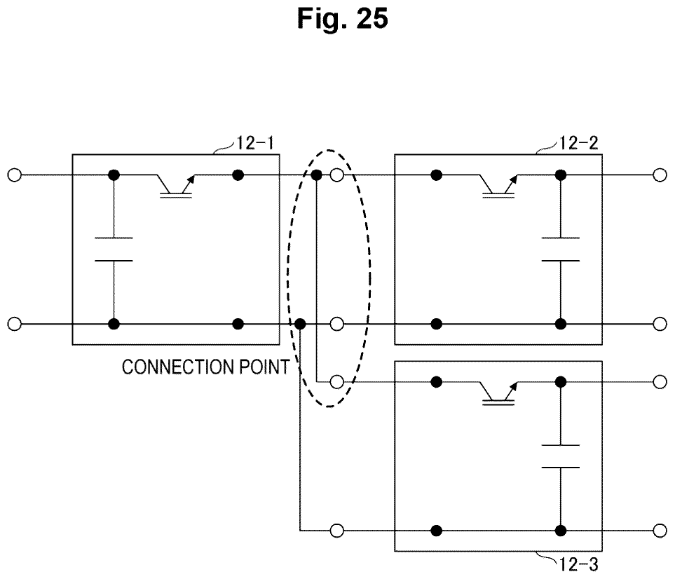

FIG. 25 is a diagram illustrating an example of the branch breaking circuit according to Example 3 of the embodiment of the present invention. As described in Example 2, by controlling operations of the breakers in cooperation, the connection point side of each breaker does not have a connection with a load device and the like any more, and the capacitor, the diode, and the like become unnecessary. Therefore, they are removed and an integrated configuration (systemization) is achieved.

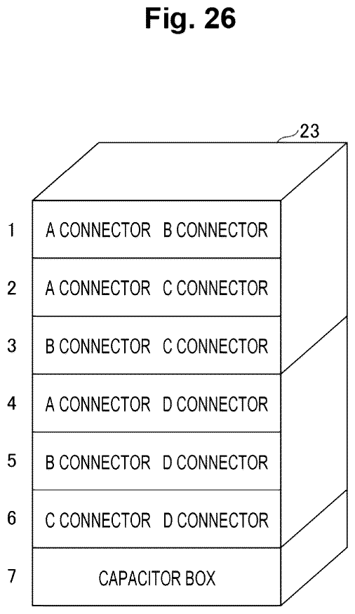

FIG. 26 is a diagram illustrating an example of the housing of the breaker according to Example 3 of the embodiment of the present invention. A housing 23 has a capacitor box in a seventh slot. The slot may be replaced according to a condition (a rated current or a voltage suppression level, etc.). Moreover, capacitors that are likely to deteriorate may be slotted and replaced.

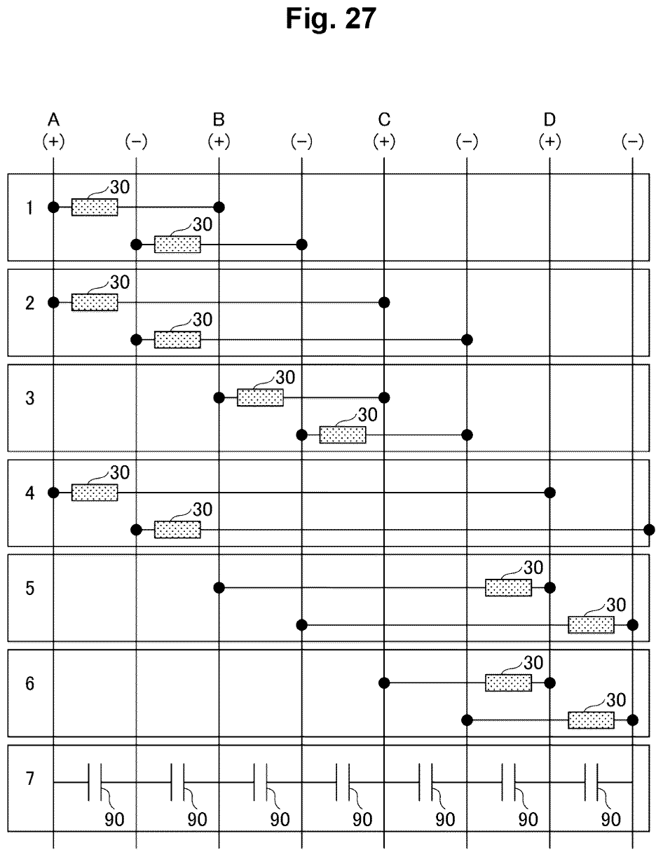

FIG. 27 is a diagram illustrating an example of a circuit of a breaker according to Example 3 of the embodiment of the present invention. As in the example in the multi-line connection diagram illustrated in FIG. 27, the branch breaking circuit illustrated in FIG. 25 can be implemented by mounting a capacitor 90 on the output side of each port.

According to this example, the capacitor, the diode, and the like on the connection point side of each breaker are eliminated and an integrated configuration is achieved. As a result, the cost of the breaker is reduced, and downsizing is realized. Accordingly, it is possible to realize integration of the branch breaking circuit capable of coping with a complicated network.

### Summary of Embodiment

In the present specification, at least a breaker and an interruption method described in the following clauses are described.

### Clause 1

A breaker including a plurality of breaking circuits for breaking a current,
in which the plurality of breaking circuits include capacitors on output sides that are not connected with each other.

### Clause 2

The breaker according to clause 1, including:
a breaking unit for breaking a current in two directions; and
a housing including a plurality of slots in which the breaking unit is inserted, and a circuit wired in advance so as to be connected between different points according to a slot in which the breaking unit is inserted,
in which the housing includes a slot for accommodating the capacitor.

### Clause 3

An interruption method of breaking a current in multiple directions by means of a breaker,
in which the breaker includes a plurality of breaking circuits for breaking a current, and
the plurality of breaking circuits include capacitors on output sides that are not connected with each other.

Although the present embodiment has been described above, the present invention is not limited to such a specific embodiment, and various modifications and changes can be made within the scope of the gist of the present invention described in accompanying claims.

### REFERENCE SIGNS LIST

1 Power supply system
10 Breaking unit
11 Connector
12 Internal circuit
20, 21 Housing
22 Breaker
30 Slot
40 Breaking unit
50 Converter
60 Control device
61 Control unit
62 Storage unit
63 Determination unit
64 Monitoring unit
65 Display unit
66 Communication unit
70 Insulation monitoring device
80 Database
101 First electric vehicle
102 Second electric vehicle
103 First solar power generation facility
104 Wind power generation facility
105 Second solar power generation facility
106 First building
107 Second building
108 Train
109 First data center
110 Second data center
111 Charging facility
121 Switch
122 Capacitor
123 Diode
901 Two-way breaker
902 Three-way breaker
903 Four-way breaker
904 Five-way breaker
905 Six-way breaker
1000 Drive device
1001 Recording medium
1002 Auxiliary storage device
1003 Memory device
1004 CPU
1005 Interface device
1006 Display device
1007 Input device
1008 Output device

1. A circuit breaker comprising:
a plurality of breaking circuits configured to interrupt a current,
wherein each breaking circuit of the plurality of breaking circuits includes a capacitor on an output side on which at least another breaking circuit, among the plurality of breaking circuits, is not coupled to the breaking circuit.

2. The circuit breaker according to claim 1 comprising:
a plurality of breaking units each of which is configured to interrupt the current flowing in two directions among a plurality of directions; and
a housing including a plurality of slots in which the respective breaking units are inserted,
wherein the housing houses a circuit in which each of the plurality of breaker units is coupled between points of different lines in a corresponding slot among the plurality of slots, and
wherein capacitors of the plurality of breaking circuits are housed in a same slot on the output side, among the plurality of slots.

3. An interruption method of interrupting a current flowing in each of multiple directions by a circuit breaker, the circuit breaker including a plurality of breaking circuits each of which includes a capacitor on an output side on which at least another breaking circuit, among the plurality of breaking circuits, is not coupled to the breaking circuit, the interruption method comprising:
interrupting the current in each of the multiple directions, using the plurality of breaking circuits in the circuit breaker.
